(19) United States
(12) Patent Application Publication
(10) Pub. No.: US 2012/0137274 A1
(43) Pub. Date: May 31, 2012

(54) SOFTWARE APPLICATION FEEDBACK COLLECTION SYSTEM AND METHOD

(75) Inventor: TENG-YU TSAI, Tu-Cheng (TW)

(73) Assignee: HON HAI PRECISION INDUSTRY CO., LTD., Tu-Cheng (TW)

(21) Appl. No.: 13/195,932

(22) Filed: Aug. 2, 2011

(30) Foreign Application Priority Data
Nov. 29, 2010 (TW) 99141307

(51) Int. Cl. G06F 9/44

(52) U.S. Cl. 717/128

(57) ABSTRACT

A software application feedback collection system includes a creating module, a usage recorder, an exception recorder, and a sending module. The creating module creates a feedback file in a storage system of the computing device when the feedback file does not exist. The usage recorder obtains usage information regarding usage of the software application and stores the usage information in the feedback file. The exception recorder acquires exception information regarding an exception of the software application and stores the exception information in the feedback file. The sending module sends the feedback file to a server via a network according to a determination that a predetermined criterion is met.

### BACKGROUND

1. Technical Field

The disclosure generally relates to a software application feedback collection system and a software application feedback collection method.

2. Description of Related Art

Software application feedback is often extremely valuable for developers to provide continuous improvement in software development. However it is not sufficiently efficient enough to get user feedback in a way that users can post their feedback to software developers initiatively via a call center, an email box, or an online forum. Therefore, there is room for improvement in software application feedback collection.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic diagram of one embodiment of a computing device including a feedback collection system.

FIG. 2 is a schematic diagram of one embodiment of function modules of the feedback collection system of FIG. 1.

FIG. 3 is an operational flow diagram representing an exemplary embodiment of a method for collecting software application feedback.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or Assembly. One or more software instructions in the modules may be embedded in firmware, such as EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

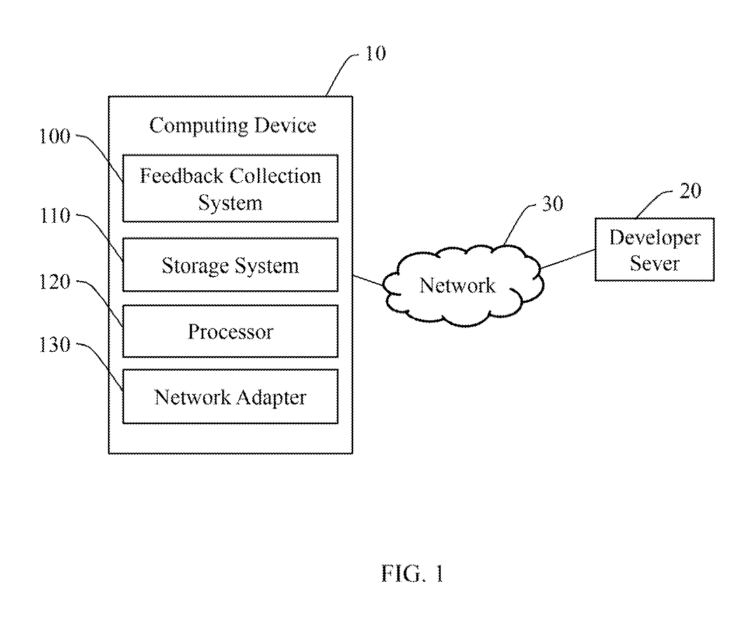

FIG. 1 is a schematic diagram of one embodiment of a computing device 10. In the embodiment, the computing device 10 may include a feedback collection system 100, a storage system 110, at least one processor 120, and a network adapter 130. The computing device 10 implements the functions of the feedback collection system 100. The feedback collection system 100 may communicate with a developer server 20 and send software application feedback to the developer server 20 via a network 30. The computing device 10 may be a desktop computer, a laptop computer, a tablet PC or a smart phone. Developers of a software application maintain the developer server 20. The developer server 20 can receive software application feedback from the computing device 10 and then provide the feedback to the developers for continuous improvement in software development.

In one embodiment, the storage system 110 may be a magnetic or an optical storage system, such as a hard disk drive, an optical drive, or a tape drive. The network adapter 130 may be a network interface card using a specific physical layer and data link layer standard such as Ethernet or Wi-Fi. The network 30 may be a local area network (LAN) or a wide area network (WAN), such as the Internet.

At least one operating system (OS) is installed in the computing device 10, which manages computer hardware resources and provides common services for execution of various software applications. A user can install one or more software applications in the operating system.

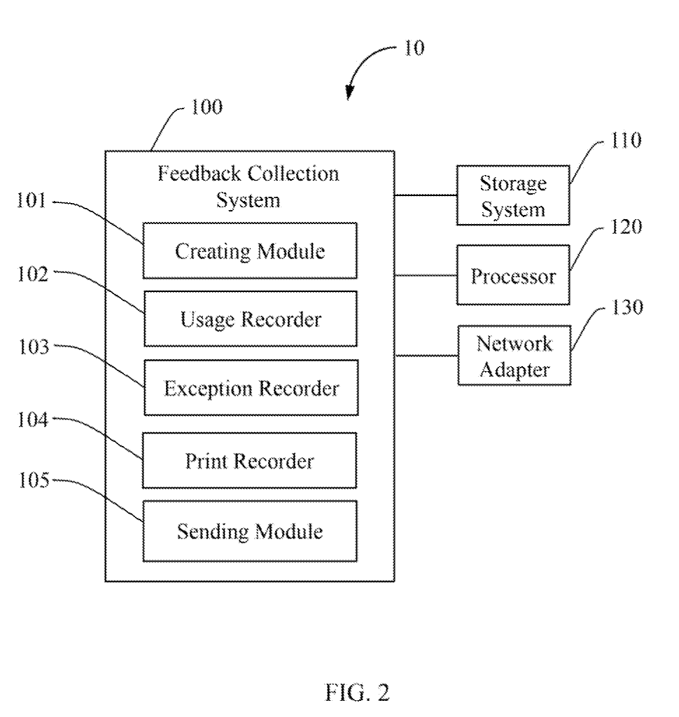

FIG. 2 is a schematic diagram of one embodiment of function modules of the feedback collection system 100. In the embodiment, the feedback collection system 100 includes a creating module 101, a usage recorder 102, an exception recorder 103, a print recorder 104, and a sending module 105. In some embodiments, each of the modules 101-105 may be a software program including one or more computerized instructions that are stored in the storage system 110 and executed by the processor 120.

The creating module 101 may check whether there is a feedback file in the storage system 110. When there is no feedback file in the storage system 110, the creating module 101 can create a feedback file in the storage system 110. The feedback file may store feedback information of a software application installed in the computing device 10. In one embodiment, the feedback information is stored in the feedback file in an extended markup language (XML) format. The creating module 101 may further associate a unique version number with the created feedback file to identify the feedback file and facilitate feedback management for developers.

The usage recorder 102 may obtain usage information regarding usage of a software application and store the usage information in the feedback file. The usage information may include number of times that a software application has been started, total time that a software application has been run, and/or timestamp that a software application is started for every time.

The exception recorder 103 may acquire exception information regarding an exception of a software application and store the exception information in the feedback file. The exception of the software application may be a failure of the software application to start correctly or a failure of the software application to run with less than expected functionality.

The print recorder 104 may record print information regarding print object, paper size and print timestamp in the feedback file. The print recorder 104 can collect a preference of a user by recording the print information. The preference may reflect which type of print object, what size of paper and what time a user prefers to print.

The sending module 105 may determine whether a predetermined criterion is met. When the predetermined criterion is met, the sending module 105 can send the feedback file to the developer server 20 via the network 30. The predetermined criterion may be stored in the storage system 110. The predetermined criterion may be detection of an event that a timer triggers every a period of time, such as 5 days, or detection that size of the feedback file reaches a threshold, such as 2 MB.

In one embodiment, in order to enhance the security of the feedback file, the sending module 105 may encrypt the feedback file before sending the feedback file to the developer server 20 and delete the feedback file after sending the feedback file to the server. The deletion of the feedback file can also save space of the storage system 110.

Most of operating systems have a set of built-in system tools or services that may be utilized to collect software application feedback. Take the ANDROID™ for example. If the operating system of the computing device is ANDROID™, the usage recorder 102 may invoke a package manger, which is one of standard components provided by ANDROID™, to obtain usage information of a software application. The package manger is designed to record information about the process of installing, running, upgrading, configuring, and removing software applications for ANDROID™. When an event or exception of a software application occurs, a log stream will be generated by ANDROID™. The exception recorder 103 may acquire exception information by monitoring the log stream. ANDROID™ provides a standard component called paper out manager service that manages print jobs. The print recorder 104 may obtain print information by monitoring the paper out manger service.

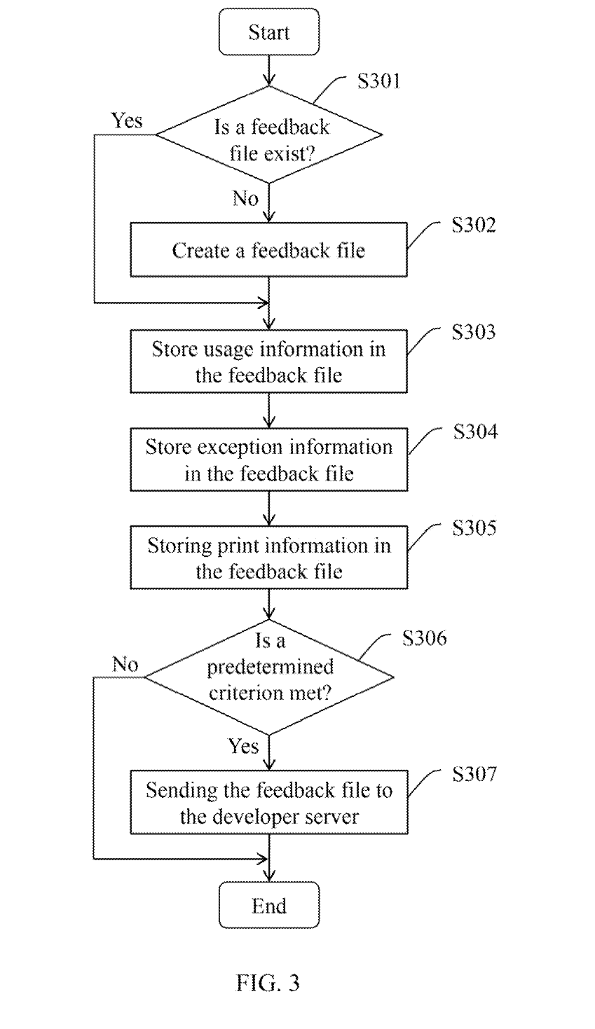

FIG. 3 is a flowchart illustrating one embodiment of a method for collecting software application feedback. The method may include the following steps.

In step S301, the creating module 101 checks whether there is a feedback file in the storage system 110. If there is no feedback file in the storage system 110, the flow goes to step S302, otherwise the flow goes to step S303.

In step S302, the creating module 101 creates a feedback file in the storage system 110.

In step S303, the usage recorder 102 obtains usage information regarding usage of a software application and stores the usage information in the feedback file.

In step S304, the exception recorder 103 acquires exception information regarding an exception of a software application and stores the exception information in the feedback file.

In step S305, the print recorder 104 records print information regarding print object, paper size and print timestamp in the feedback file.

In step S306, the sending module 105 determines whether a predetermined criterion is met. If the predetermined criterion is met, the flow goes to step S307, otherwise the flow ends.

In step S307, the sending module 105 sends the feedback file to the developer server 20 via the network 30. In order to enhance the security of the feedback file, the sending module 105 encrypts the feedback file before sending the feedback file to the developer server 20. In one embodiment, the sending module 105 deletes the feedback file after the feedback file is sent to the developer server 20.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

Depending on the embodiment, certain steps or methods described may be removed, others may be added, and the sequence of steps may be altered. It is also to be understood that the description and the claims drawn for or in relation to a method may include some indication in reference to certain steps. However, any indication used is only to be viewed for identification purposes and not as a suggestion as to an order for the steps.

What is claimed is:

1. A computer-implemented method for collecting software application feedback in a computing device with an operating system (OS) and a software application installed therein, the method comprising:
creating a feedback file in a storage system of the computing device when the feedback file does not exist in the storage system;
obtaining usage information regarding usage of the software application and storing the usage information in the feedback file;
acquiring exception information regarding an exception of the software application and storing the exception information in the feedback file; and
sending the feedback file to a server via a network according to a determination that a predetermined criterion is met.

2. The method of claim 1, further comprising recording print information regarding print object, paper size and print timestamp in the feedback file.

3. The method of claim 1, wherein the usage information comprises number of times that the software application has been started.

4. The method of claim 1, wherein the usage information comprises total time that the software application has been run.

5. The method of claim 1, wherein the usage information comprises timestamp that the software application is started for every time.

6. The method of claim 1, wherein the exception of the software application comprises a failure of the software application to start correctly.

7. The method of claim 1, wherein the exception of the software application comprises a failure of the software application to run with less than expected functionality.

8. The method of claim 1, wherein the predetermined criterion comprises detection of an event that a timer triggers every a period of time.

9. The method of claim 1, wherein the predetermined criterion comprises detection that size of the feedback file reaches a threshold.

10. The method of claim 1, further comprising deleting the feedback file after sending the feedback file to the server.

11. A system for collecting software application feedback in a computing device with an operating system (OS) and a software application installed therein, the system comprising:
a creating module adapted to create a feedback file in a storage system of the computing device when the feedback file does not exist in the storage system;
a usage recorder adapted to obtain usage information regarding usage of the software application and store the usage information in the feedback file;
an exception recorder adapted to acquire exception information regarding an exception of the software application and store the exception information in the feedback file; and
a sending module adapted to send the feedback file to a server via a network according to a determination that a predetermined criterion is met.

12. The system of claim 11, further comprising a print recorder adapted to record print information regarding print object, paper size and print timestamp in the feedback file.

13. The system of claim 11, wherein the usage information comprises number of times that the software application has been started.

14. The system of claim 11, wherein the usage information comprises total time that the software application has been run.

15. The system of claim 11, wherein the usage information comprises timestamp that the software application is started for every time.

16. The system of claim 11, wherein the exception of the software application comprises a failure of the software application to start correctly.

17. The system of claim 11, wherein the exception of the software application comprises a failure of the software application to run with less than expected functionality.

18. The system of claim 11, wherein the predetermined criterion comprises detection of an event that a timer triggers every a period of time.

19. The system of claim 11, wherein the predetermined criterion comprises detection that size of the feedback file reaches a threshold.

20. The system of claim 11, wherein the sending module is further adapted to delete the feedback file after sending the feedback file to the server.
